(19) United States
(12) Patent Application Publication
(10) Pub. No.: US 2003/0115586 A1
(43) Pub. Date: Jun. 19, 2003

(54) Method for measuring and analysing audience on communication networks

(76) Inventors: Herve Lejouan, Garges les Gonesse (FR); Ludovic Dubost, Paris (FR); Erwan Arzur, Paris (FR); Laurent Nicolas, Paris (FR); Laurent Azzopardi, Clamart (FR)

Correspondence Address: Greenberg Traurig, Suite 400E, 2450 Colorado Avenue, Santa Monica, CA, 90404, US

(21) Appl. No.: 10/148,370

(22) PCT Filed: Jun. 21, 2001
(86) PCT No.: PCT/FR00/03541

(51) Int. Cl. H04N 7/16; H04H 9/00

(52) U.S. Cl. 725/9; 725/20

(57) ABSTRACT

The invention concerns a method (20) for measuring and analysing activity on at least packet data communication network (30), [for example a communication network based on the TCP/IP protocol] of a plurality of terminals (10), using means for collecting data and equipment comprising a database for storing collected data. Said method comprises a step which consists in acquiring and analysing data concerning data exchanged over the communications network by said terminals, said data comprising at least descriptive data of each packet transmitted and received by each terminal, a step which consists in transmitting said collected data to the central equipment subsequent to analysis of the collected data and generating aggregate databases to supply data representing the activity of a panel of equipment items connected to the communications network.

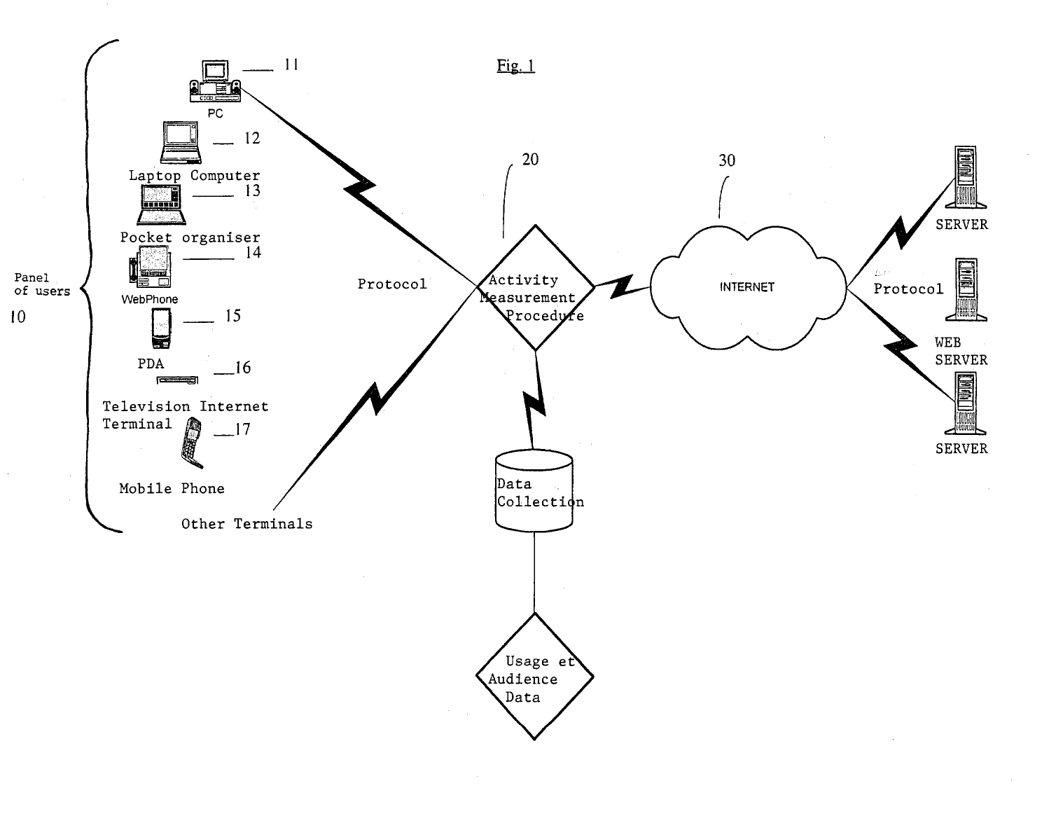

The method is characterised in that it comprises an initial step which consists in setting up and configuring operating parameters for a computer application interacting only with the network layer of the computing platform, excluding the application layer processing exchanged data with the network (browser, FTP software, messaging . . . ) on the individual terminals or on a gateway when the terminals do not allow the recording of such an application.

The present invention concerns the field of audience measurement and analysis on open and closed computer networks of the intranet, extranet or Internet type, and more generally on any type of computer network. More specifically, the invention allows the operations to be collected, memorised, transmitted and analysed that are linked to the use of the computer network on an individual terminal, especially a computer, but also any equipment fitted with an access to a computer network fitted with a physical access or not to the said network (with or without a wire).

The growing development of the Internet, in particular within the framework of business relations, and of all the means of communication such as electronic mail, data transfer using the FTP protocol, video or the HTTP protocol, requires the use of new means for measuring and analysing the audience thus allowing the users' behaviour to be studied. The classic means for measuring and analysing the audience, in particular the methods using questionnaires associated to panels of users, do not allow the behaviours linked to the new means of communication to be studied specifically.

The patent application PCT WO98/26529 describes a measurement and analysis system which records the use of on-line and off-line services by means of devices for interactive services. The said system measures and analyses in particular the access to homepages, to advertisements and to other resources. The means used consist of the use of recordings of activities by performing the sorting between the different types of actions performed by the user then a prior processing of the data received according to their type.

The patent U.S. Pat. No. 5,675,510 describes an audience measurement and analysis system allowing certain actions performed by the user to be recorded. The patented system measures, analyses and transmits the data linked to the use of a computer thanks to an activity log. This log includes the data linked to some pre-determined events and allows the communications programs and functions launched by the user to be known. This data is then analysed to determine the user's habits of use.

This method uses activity logs and the messages used by the operating system internally to determine which resources are used. It has the major drawback that it depends on the operating system and grants access to a restricted number of data.

The present invention allows the methods for reliable data collection concerning the use of a network by a terminal to be improved. The invention allows all the types of communications linked to a computer network to be studied such as the Internet, especially electronic mail, live communications, multimedia data transfer, games and any other standardised or proprietary communications protocol using packet data transfer following the IP protocol.

The present invention also allows the establishment of panels of individual users to be supplied so as to improve the quality of the audience studies performed for any type of actor using an open or closed communications network.

The present invention is related to a procedure for measuring and analysing the activity on at least one data packet communications network as described in claim 1.

The procedure for measuring and analysing the activity on at least one data packet communications network, from a plurality of terminals, implements some means for data collecting and transmitting the said data collected to a central unit including a database for the recording of the data collected. The said procedure includes a stage for acquiring the information relating to the data exchanged on the communications network by the terminals, with the said information including at least the information for describing each packet sent or received by each terminal, a stage for transmitting the said information collected to the central unit, and a subsequent stage for the analysis of the information collected and for the creation of aggregated databases in order to provide the data representing the activity of a panel of units connected to the communications network.

The procedure is characterised by the fact that it includes an initial installation and configuration stage for the operating parameters for a computer application interacting only with the network layer of the operating system, with the exclusion of the application layer for using the data exchanged with the network (browser, FTP software, message system, . . . ) on the terminals or on a gateway when the terminals do not allow the recording of such an application.

In a variation, the stage for the analysis and acquisition of information relating to the data exchanged on the communications network is operated in real time.

The communication on the communications network is preferentially based on the IP protocol.

In a variation, the initial stage for installation consists of installing a computer application on the terminals for the analysis and collection of data from the communications protocol exchanged by the terminal on the network.

In another variation, the initial stage for installation consists of installing a computer application for data collection on some gateways (WAP, UMTS, GPRS, I-MODE, . . . ) for linking between the terminals and the network.

The data collected by the terminals or the gateways are transmitted to a server by the communications network itself, and the data on the activities are stored in the memory in the central unit.

Depending on the variations, it is possible to:

memorise the data collected in a specific file in the terminal or in a server accessible by the said communications network or by another means.

perform a stage for encoding the data collected.

perform a stage for compressing the data collected.

When the procedure for the control of the data sent out from terminals does not allow the installation of the computer application for measuring (WAP, UMTS, GPRS, I-MODE, . . . ), it will preferentially include an initial stage for registering the user with a server [http], with the said server assigning in return to the said user a unique password; and a stage for setting the parameters of the user's terminal.

The measurement stage includes the recording in a live memory of all the requests sent and the responses received by the user as well as the recording of the time and date of the said requests.

The initial registration stage consists of saving the data for identifying the user in the measurement server memory [http], as well as the request for the homepage that he/she has requested, and the result of applying a function for cutting the said request.

The stage for setting the parameters of the terminal may be performed by sending a message (SMS, . . . ) containing the user's address attached.

The procedure also involves, preferentially, a stage for specifying a limited population of terminal users forming a panel, with the said procedure involving a stage for the acquisition of data relating to the data exchanged on the communications network only by the specified sub-set of terminals, and a subsequent stage for the analysis of the data gathered to provide some representative data on the activity of the sub-set of units connected to the communications network.

The data gathered by the server sent from the terminals include, apart from the information describing each packet sent or received by the terminal, a password for the user of the said terminal, with the procedure including a subsequent stage for segmenting the data, by comparing each data received by the server with a database containing a table for assigning the data.

The procedure may include an additional stage consisting of creating a database specific to a client who is a user of the procedure, containing at least all the data gathered for the latter, with the client user having a computerised system available to consult this specific database.

At least one targeted sampling application may also appear amongst the display means on the said terminal whose content depends on the said information relating to the data exchanged on the network.

An historic file of the responses provided to the said targeted samplings is created and recorded on the level of the said terminal or on the level of the server which sent the said application.

The procedure includes a stage for classifying the different types of activities on a communications network, a stage for specifying a limited population of users forming a panel, with the said procedure including a subsequent stage for summarising the information analysed in order to provide some representative data about the activity of the sub-set of units connected to the communications network.

The procedure may include an additional stage for setting up a database specific to a client who is a user of the procedure, containing at least all the data collected for the latter, with the client user having a computerised system available to consult this specific database.

In a preferred variation, the analysis stage for the data collected consists of processing at least part of the data including an identification for the Internaut (ID_{Internaut}; the response to the request made (Id_{page}; the date of the start of consulting the said response by the said Internaut [T_{pd}], and the date of the end of consulting the result of the request by the said Internaut [T_{pf}], the session identification [Idₛ]; the start of a session [T_{sD}] corresponding to the start of a connection to the network by the said Internaut, the end of the said session [T_{sf}].

This stage allows a certain number of indices to be determined based on the said information:

a Gross Day Point (GDP) index corresponding to the percentage of Internauts from the panel consulting a certain page, multiplied by the number of days of connection per Internaut over a given period;

a Gross Session Point (GssesP) index corresponding to the percentage of Internauts multiplied by the number of different Web pages per Internaut;

a Gross Display Point (GdisP) index corresponding to the percentage of Internauts multiplied by the number of pages, different or not, posted per Internaut;

a GPP/GdisP ratio index;

a Gross Duration Point (GdurP) index corresponding to the percentage of Internauts multiplied by the duration in minutes of connection per Internaut;

a TARGET REACH index corresponding to the number of Internauts from a given target, for a given domain, with respect to the number of individuals in the target;

a TARGET SHARE index defined by the number of Internauts from the target who have visited a domain (site, sector, . . . ) with respect to the overall number of Internauts who have visited the domain (site, sector, . . . );

a TARGET DISPLAY SHARE index defined by the number of pages posted by the target with respect to the number of pages posted for all the Internauts on the domain (site, sector, . . . );

a BANNER DISPLAY SHARE index defined by the number of advertising banners seen by a target on a domain (site, sector, . . . ) with respect to the number of advertising banners seen by the whole group of Internauts on the domain (site, sector, . . . );

a PAGES WITH BANNER DISPLAY SHARE index defined by the number of pages with advertising seen by the target on the domain (site, sector, . . . ) with respect to the number of pages with advertising seen by the whole group of Internauts on the domain (site, sector, . . . );

a REACH AFFINITY index defined by the proportion of visitors to the domain (site, sector, . . . ) within the target group with respect to the proportion of the target group amongst the users of Internet;

a DISPLAY AFFINITY index defined by the number of pages seen by a target on a site, a domain or a service, with respect to the total number of pages seen on the site, the domain;

a BANNER AFFINITY index defined by the percentage of advertising banners seen by a target on a site, a domain or a service, with respect to the total number of advertising banners seen on the site, the domain;

a PAGES WITH BANNER AFFINITY index defined by the percentage of pages with advertising seen by a target on a site, a domain or a service, with respect to the total number of pages with advertising seen on the site, the domain;

The procedure may also include a later stage for detecting advertising data through an analysis of the data collected in comparison with a reference base and statistical and behavioural collation of the said information detected.

The present invention also relates to a unit for measuring activity characterised by the fact that it includes a server for measuring linked to the Internet network, with the said measurement server including a database in which the user identifications and the requests corresponding to the homepages requested by the users from the panel are stored and with a calculator ensuring the detection and the conversion of the requests generated by the users.

The present invention will be better understood from reading about one mode for implementing provided below purely by way of the purposes of explanation, in reference to the FIGURE attached herewith.

The procedure (20) in accordance with the invention is a procedure for measuring and analysing the activity on a data packet communications network (30), [for example, a communications network based on the TCP/IP protocol] with a plurality of terminals (10).

These terminals may constitute, for example, a certain number of personal computers, PCs; (11), laptop computers (12), pocket organisers (13), fixed telephones with Internet or Webphone access (14), Personal Digital Assistants (15); terminals with Internet access of the television type (16), mobile telephones with Internet access of the WAP, UMTS, GPRS, I-MODE telephone type (17) or another.

The procedure (20), according to the invention, implements the means for real time analysis, data collection and transmission of the said data collected to a central unit including a database for storing the information collected. The said procedure includes a stage for the acquisition of information relating to the data exchanged on the communications network by the said terminals, with the said information including at least the information describing each packet sent or received by each terminal, thus allowing the protocols used to be analysed, a stage for the transmission of the said information collected to the central unit, and a subsequent stage for analysing the information collected and for creating databases for the data added in order to provide some representative data of the activity of a panel of units connected to the communications network.

The procedure is characterised by the fact that it includes an initial stage for the installation and configuration of the operating parameters for a computer application, with the said application interacting only with the network layer of the operating system, with the exclusion of the application layer for using the data exchanged with the network (browser, FTP software, message system, . . . ) on the individual terminals or on a gateway (when the terminals do not allow the recording of such an application).

At the time of a connection on the Internet, the data transferred following the IP protocol are intercepted by a specific program. This information is processed regardless of the operating system and the software programs used to connect. The specific means then allow the data exchanged to be analysed, filtered in real time and collected, so as to identify the information that is useful for studying the usages of the different protocols used (HTTP, SMTP, POP3, WAP or any other standard or proprietary protocol) on the computer network.

The invention thus allows this information to be intercepted in the network layer of the operating system. The invention is also applied to any terminal physically linked or not to a computer network such as wireless terminals (WAP mobile telephones, GPRS, UMTS, I-MODE . . . ).

In a variation, the initial stage for installation consists of installing a computer application on the terminals for collecting data from the communications protocol exchanged by the terminal on the network.

In another variation, the initial installation stage consists of installing a computer application for collecting data on a gateway (WAP, GPRS, UMTS, I-MODE . . . )for linking up the terminals and the network.

At the time of a connection, the TCP/IP packets are intercepted and stored in a specific log for the activity including any information that might be useful for studying the user's behaviour. This additional information consists of, for example, a time and date stamp, an identification of the terminal, an identification of the user or of the software working and using the network resources.

The use of a representative user panel allows the habits of a population and its sub-sets to be determined, by using some statistical processing methods. In order to make the implementation of this method easier, each member of the panel is then supplied with an application file with a view to processing the information collected. This application file allows the data linked to the panel member to be intercepted. It may be installed either on the latter's terminal, or on a specific server.

It is also possible to intercept the information exchanged by using software set up in a communication on the computer network, Internet for example. Any use of the software allowing the implementation of a communications protocol may be studied using this method.

The system, according to the invention, also uses some set-up tools allowing the installation of the measuring and analysis application, some means for encoding and compressing the data used for the activity log, some means for transfer specific to the activity log, as well as the means for identifying the user. The encoding and compression of the data allow the memory space occupied by the activity logs to be reduced and to improve security for the information contained in these logs, especially at the time of the transfer.

The data collected may be transferred to one, or several servers. The said data are decoded and decompressed, then they undergo specific processing techniques so as to be inserted in a database. Then the data undergo statistical processing thereby allowing the useful information to be extracted from them and to create analysis reports on the use of the terminals. The transfer of the said data may be performed following specific programming, in a periodic manner, or following individual requests.

The set of data collected by the technology, according to the invention, allows Internet usage and any type of computer network usage and the audience for the sites visited by the users to be studied at the same time.

In its favour, the invention allows a sampling window to be sent, whose content depends on the context of the information exchange, especially applicable to the analysis and the study of electronic commerce. The present invention thus allows pertinent information on the exchanges of information to be obtained (whether encoded or not), which have just been performed, because on the one hand the said sampling is carried out quickly after the action and on the other hand because the questions posed depend on the context of the exchange of information.

Once installed on the terminal of the users who are panel members, the procedure functions in the background on his/her computer and preferentially triggers its own start-up automatically. The procedure is activated when a connection using the IP protocol is launched by the user.

The procedure monitors the connections and intercepts the data packets in real time.

It records all the activities based on the Internet protocols in an activity log, but none of the data sent and/or received (in accordance with respect for the panel members' private lives).

It allows the detailed monitoring of the use of Internet protocols like HTTP, SMPTP, POP3; the monitoring of the duration, volume and sockets from other protocols such as ICQ, Audio/Video, FTP, AOL, Infonie, etc . . .

It also allows the textual triggering of a sampling application whose content adapts to the type of activity performed by the user. This application questions the user on the panel thanks to the detection of the pre-established parameters recorded by the procedure.

Since the configuration parameters allowing the triggering of the sampling application, are made up by, for example, a database of the domain names and the type of protocols.

This sampling application can be executed directly on the user's work post or on a server. The sampling application is presented in the form of a pop-up window which appears on screen to question the terminal user. The user answers the questionnaire simply by clicking on his/her mouse, the questionnaire has been targeted according to the context and the domain names detected, for example. The application takes into account the user's recurrent activity thanks to the recording of an historic file of the sampling situations and the customisation of the parameters for triggering off the application.

For the study of e-commerce, for example, the application analyses in real time the URL active on the browser and the protocol used to trigger off the sampling application. This functionality allows the user's behaviour to be discovered whichever encoding system is used for exchanging data.

It also allows the identification of the users and the analysis of the information on the level of the individual users.

All these data are added in real time to the activity log, a log that is compressed and encoded prior to any transfer.

It establishes connections with at least one particular server, following the thresholds for which the parameters may be set, in order to download the contents of the activity files into databases.

The automatic transfer of the activity logs is carried out following some thresholds set (remote setting for parameters) in the panel member's computer to one or several specific servers.

As soon as the data file is received by the particular server, a recurrent periodic process will recover this file, save it and load the data contained into a database in the particular server.

These data contained in a database then undergo some statistical processing allowing the necessary information to be taken out from it for drawing up summarised reports on the use of the terminals and behaviour. The processing of these data is carried out following a specific procedure, at pre-set times, or following individual requests.

All of the data collected by the technology according to the invention allows Internet usage or the usage of any type of computer network and the audience for the main sites to be monitored at the same time.

For the usage of e-commerce on Internet or computer networks, the aim is to provide the keys for understanding the Internauts' behaviour. The usage of the network is analysed in its different components by categories of Internauts. The procedure, according to the invention, obtains summaries of their purchase transactions, reservations, searches for information, This summary especially allows plans for customer recruitment and fidelity to be optimised.

In practice, the terminal user must first be registered on-line on the Internet site for registration planned for this purpose. During this registration, he/she is assigned a unique identification number. This number is registered by the device and shall be contained in each log sent in order to allow the identification of the user and the source of the log received.

In the case of wireless terminals, especially, the invention allows the activity to be intercepted and recorded in a log through the use of a gateway. Depending on the specific mode of implementation, the measuring stage includes the recording in a live memory of all the hits generated by the user as well as the time and the date of the detection of the said hits.

The measuring procedure, according to the invention, consists of inserting a measurement server between the WAP gateway and the Internet network servers.

The wireless terminal user must first register on-line, for example by accessing an HTML page housing a registration application form on the audience measurement operator's site based on a computer connected to the Internet network. This registration focuses on the identity of the user, some personal details in order to classify him/her, and the URL address for the homepage. This information is sent to the server in the form of a computer message. The registration server assigns a unique identification code to the user and records the results using a cutting function from the homepage. The homepage added is in the following form:

[measurement server's URL address] separator [User identification] separator [User's homepage URL address], for example,

http://wap.netvalue.com/wapmeter.html?id=XXXX & Url=YYYY.

The part before the question mark corresponds to the measurement server's Url.

The character & constitutes a second separator.

The last part corresponds to the homepage summarised in a whole name resulting from a cutting function.

This aggregate address is recorded in the user's wireless terminal memory, in the zone corresponding to the homepage address.

When the terminal user makes his/her first request based on the links present on the home page recorded, the measurement server detects all the Http links (Url) present on the page requested by the user and dynamically converts them into a full name following a cutting algorithm assigning a unique name to each Url following the model of the homepage added above.

The procedure thus allows the activity of the identified user of the terminal to be measured thanks to the storage of each one of the Urls generated in a log file.

All of the data collected by the technology, according to the invention, allows both the usage of the Internet and the usage of any type of computer network as well as the audience for the main Web sites to be measured at the same time. Advertising forms part of a specific study within the different processes for processing the data collected. Furthermore, the invention includes a stage for searching for advertising, under the different forms that the latter may use on the communications network, to which the users measured have been exposed.

For the usage of the Internet or the usage of computer networks, the aim is to provide the keys for understanding the Internauts' behaviour. The usage of the network (Web, mail and other usages) is analysed in its different components (frequency of use, time spent, share rates between usages, type of attachment for e-mails, . . . ) by categories of Internauts (and especially by “PMG” spread: Small-Medium-Large Internauts). The application from the procedure offers the possibility for crossed-sorting between the Small-Medium-Large Internauts for each network usage, the crossing of the Internauts' characteristics (age, sex, PCs . . . ) with all the usages that they make of the network. The procedure, according to the invention, obtains results in their marketing operations, especially in the optimisation of the plans for customer recruitment and fidelity.

The procedure allows the analysis of the weight for each sector of activity on the Web (banking, finance, car manufacturers, transport, leisure . . . ) and about the Internauts' switching between sectors: pages hit, time spent, name of sessions.

It also allows the measurement and analysis of the audience for the main sites by two categories of audience indicators. The first category includes the unit indices: rate of coverage (name of single visitors per month), frequency, average number of days of connection, of single pages or different hits, record of pages, of time spent on a site, total duration spent on the sites, share of the Web activity within the sessions.

The second category includes the compound indices. These indices produce a summary between the coverage and the different unit indices: Gross Day Point, Gross Session Point, Gross Page Point, Gross Display Point, Gross Duration Point.

These indicators are monitored for the sites revealing a significant audience (by names of domains and by sites: grouping together of domains), and by sectors (calculated on the basis of several thousand categorised sites representing over 80% of Internet traffic).

Indices for Frequency of Exposure

Gross Day Point (GDP): Percentage of Internauts multiplied by the number of days of connection per Internaut over the period.

GssesP—Gross Session Point: Percentage of Internauts multiplied by the number of Web sessions per Internaut. With regards to the share of multiple visitors calculated on the number of sessions, this indicator allows the domains to be classified.

GPP—Gross Page Point: Percentage of Internauts multiplied by the number of different Web pages per Internaut.

GdisP—Gross Display Point: Percentage of Internauts multiplied by the number of Web pages (different or not) hit per Internaut. The GPP/GdisP ratio measures the fact that the Internauts have seen the same page several times.

GdurP—Gross Duration Point: Percentage of Internauts multiplied by the duration (of the session in minutes) per Internaut.

Reach: Number of visitors for a domain with respect to the number of Internauts.

Target Reach: Number of visitors from the target for a given domain with respect to the number of individuals in the target.

Target Share: Number of individuals from the target who have visited a domain (site, sector, etc . . . ) with respect to the overall number of Internauts who have visited the domain (site, sector, etc . . . ).

Target Display Share: Number of pages posted by the target with respect to the number of pages posted for all the Internauts on the domain (site, sector, etc . . . ).

Banner Display Share: Number of advertising banners seen by a target on a domain (site, sector, etc . . . ) with respect to the number of advertising banners seen by the whole group of Internauts on the domain (site, sector, etc . . . )

Pages With Banner Display Share: Number of pages with advertising seen by a target on a domain (site, sector, etc . . . ) with respect to the number of pages with advertising seen by all the Internauts on a domain (site, sector, etc . . . ).

On the basis of these indices, different variations for calculating affinities are possible, especially for the coverage, the categories of Internauts, the sectors or domains . . .

Reach Affinity: (affinity on the audience or coverage share): This indicator measures the fact that the proportion of visitors to the domain from within the target group with respect to the proportion of the target group amongst the users of Internet.

This indicator is over 100 if the coverage rate for the target group is higher than the rate of coverage of all the users of Internet.

$$Reach Affinity \frac{\frac{\begin{matrix}Number of visitors belonging \\ to the target on a domain\end{matrix}}{Number of visitors on a domain}}{\frac{Number of Internauts belonging to the target}{Number of Internauts}} \times 100$$

Display Affinity (affinity on the pages seen): This index is calculated on the basis of the number of pages seen by a target on a site, a domain or a service in relation to the total number of pages seen on the site, the domain or service. (target: man, woman, sex, classed by age, type of Internauts . . . ).

It measures the probability that a page supplied at random on the site, group of sites or service will be hit by someone from the selected target.

It allows the sites, group of sites or services to be found on which the purchase of space (to place advertising banners) is the most effective, that is to say to reach a percentage of the target selected in the most effective way.

The formula below is given for a domain. An identical formula is calculated for all the levels of aggregation.

$$Display Affinity \frac{\frac{Number of pages hit by the target on the domain}{\begin{matrix}Number of pages hit on the \\ domain for all Internauts\end{matrix}}}{\frac{\begin{matrix}Number of pages hit by the \\ target on all the domains\end{matrix}}{\begin{matrix}Number of pages hit by all \\ Internauts on all domains\end{matrix}}} \times 100$$

The domain which has the highest affinity index for advertising banners is the domain on which it is the most effective to place advertising to hit the target, in terms of pages seen.

Banner Affinity (affinity on the advertising banners): This index is calculated based on the percentage of advertising banners seen by a target (target: man, woman, sex, classed by age, type of Internaut . . . ) on a site, a domain or a service with respect to the total number of advertising banners seen on the site, the domain or the service.

When the Banner Affinity is greater than 100, it indicates that the proportion of advertising banners seen by a target on a site is greater than the proportion of advertising banners seen by all the users on all the sites.

The formula below is given for a domain. An identical formula is calculated for all the levels of aggregation (site, sector, sub-domain, etc . . . )

$$Banner Affinity \frac{\frac{\begin{matrix}Number of advertising banners seen by \\ the target on the domain\end{matrix}}{\begin{matrix}Number of advertising banners seen by \\ all Internauts on the domain\end{matrix}}}{\frac{\begin{matrix}Number of advertising banners seen by the \\ target on all the domains\end{matrix}}{\begin{matrix}Number of advertising \\ banners seen by all Internauts\end{matrix}}} \times 100$$

The domain which has the highest affinity index for advertising banners is the domain on which it is the most effective to place advertising to hit the target, in terms of advertising banners.

Pages with Banner Affinity (affinity on the pages with advertising): This index is calculated based on the percentage of pages with advertising seen by a target (target: man, woman, sex, classed by age, type of Internaut . . . ) on a site, a domain or a service with respect to the total number of pages with advertising seen on the site or the domain.

When the ‘Pages with Banner Affinity’ is greater than 100, it indicates that the proportion of pages with advertising banners seen by a target on a site is greater than the proportion of pages with advertising banners seen by all the users on all the sites.

The formula below is given for a domain. An identical formula is calculated for all the levels of aggregation (site, sector, sub-domain, etc . . . ).

$$Pages with Banner Affinity \frac{\frac{\begin{matrix}Number of pages with advertising seen \\ by the target on the domain\end{matrix}}{\begin{matrix}Number of pages with advertising seen \\ by all Internauts on the domain\end{matrix}}}{\frac{\begin{matrix}Number of pages with advertising seen \\ by the target on all the domains\end{matrix}}{\begin{matrix}Number of pages with advertising seen \\ by all Internauts on all the domains\end{matrix}}} \times 100$$

The domain which has the highest affinity index on pages with advertising is the domain on which it is the most effective to place advertising to hit the target, in terms of pages with advertising.

The indices constitute a tool for measuring the effectiveness of purchasing advertising space on the Internet and the cornerstone for media planning supply. They help and guide the clients in terms of positioning, strategic planning, advertising sales and purchase decisions. These indicators have been developed to meet clients' growing needs to have behavioural data available on Internauts so as to implement some means for differentiating between the sites and the other entities on the Internet.

The invention allows a generic tool for data analysis to be offered through a secure Web site application. It offers some possibilities for crosschecking the socio-demographic characteristics of the Internauts (age, sex, PCs, . . . ) and behavioural traits (sites visited, number of e-mails, etc . . . ) with the audience for the sites. It allows some audience ratios to be established for the sites or domains and the different usages of the Internet or a computer network. The application also allows the advertising media diffused on the Internet to be identified and displayed and to analyse the socio-demographic profiles of the Internauts who are exposed to them. This data may be delivered for all types of advertising media: banners, buttons, before an analysis by sector and product.

These data are interpreted and aggregated using a range of products.

According to one specific variation for its implementation, the procedure, according to the invention, includes a stage for specifying a sub-set of equipped terminals so that they may be used for generic measuring and analysis or limited to a specific population. The procedure, according to this variation, includes a stage for the acquisition of information relating to the data exchanged only between the communications network and the said sub-set of terminals, and a subsequent stage for the analysis of the information collected in order to provide representative data on the activity of the sub-set of units connected to the communications network.

The invention is described above by way of an example. It is understood that an expert in this field is able to produce different variations of the invention without therefore exceeding the framework of the patent.

1. Procedure (20) for measuring and analysing the activity on at least one data packet communications network (30) with a plurality of terminals (10), implementing the means for data collection and for the transmission of the said data collected to a central unit including a database for storing the information collected, with the said procedure including a stage for analysis and acquisition of information relating to the data exchanged on the communications network by the said terminals. With the said information including at least the information describing each packet sent or received by each terminal, a stage for transmitting the said information collected to the central unit, and a stage for creating an aggregated database in order to supply representative data on the activity of a panel of units connected to the communications network, characterised by the fact that the procedure includes an initial stage for the installation and configuration of the working parameters for a computer application interacting only with the network layer of the operating system, excluding the application layer for operating the data exchanged with the network (Browser, FTP software, message services, . . . ) on the individual terminals or on a gateway when the terminals do not allow the recording of such an application.

2. Procedure for measuring and analysing the activity on at least one communications network, according to claim 1, characterised by the fact that the stage for the analysis and acquisition of information relating to the data exchanged on the communications network is operated in real time.

3. Procedure for measuring and analysing the activity on at least one communications network, according to claim 1 or claim 2, characterised by the fact that the communications on the communications network are based on the IP protocol.

4. Procedure for measuring and analysing the activity on at least one communications network, according to any one of claims 1 to 3, characterised by the fact that the said initial stage for installation consists of installing a computer application on the terminals for the analysis and collection of data from the communications protocol exchanged by the terminal on the network.

5. Procedure for measuring and analysing the activity on at least one communications network, according to any one of claims 1 to 3, characterised by the fact that the said initial stage for installation consists of installing a computer application for the analysis and collection of data on some gateways [WAP, UMTS, GPRS, I-MODE . . . ] for the link between some terminals and the network.

6. Procedure for measuring and analysing the activity on at least one communications network, according to at least one of the preceding claims, characterised by the fact that the data collected by the terminals or the gateways are sent to a server by the communications network itself, and by the fact that the data regarding the activities are recorded in the memory of the central unit.

7. Procedure for measuring and analysing the activity on at least one communications network, according to at least one of claims 1 to 4, characterised by the fact that the data collected are to be recorded in a specific file in the terminal.

8. Procedure for measuring and analysing the activity on at least one communications network, according to any one of the preceding claims, characterised by the fact that the data collected are recorded on a server accessible by the said communications network or by another means.

9. Procedure for measuring and analysing the activity on at least one communications network, according to any one of the preceding claims, characterised by the fact that a stage is performed for encoding the data collected.

10. Procedure for measuring and analysing the activity on at least one communications network, according to any one of the preceding claims, characterised by the fact that a stage is performed for compressing the data collected.

11. Procedure for measuring and analysing the activity on at least one communications network, according to any one of claims 5 to 9, characterised by the fact that it includes an initial stage for registering the user with a server [http], with the said server assigning in return a unique identification code to the said user; and a stage for setting the parameters for the user's terminal.

12. Procedure for measuring and analysing the activity on at least one communications network, according to claim 11, characterised by the fact that the measurement stage includes the recording in a live memory of all the requests sent and the responses received by the user, as well as the time and date stamp record for the said requests.

13. Procedure for measuring and analysing the activity on at least one communications network, according to claim 11 or claim 12, characterised by the fact that the initial stage for registration consists of saving the user's identification data in a memory on the measurement server [http], as well as the request for the homepage that he/she has chosen and the result of the application of a cutting function for the said request.

14. Procedure for measuring and analysing the activity on at least one communications network, according to at least one of claims 11 or 12, characterised by the fact that the stage for setting the parameters of the terminal is performed by sending a progress message (SMS . . . ) containing the user's address attached.

15. Procedure for measuring and analysing the activity on at least one communications network, according to any one of the preceding claims, characterised by the fact that it includes a stage for specifying a limited population of terminal users forming a panel, with the said procedure including a stage for the acquisition of information relating to the data exchanged on the communications network only by the restricted sub-set of terminals, and a subsequent stage for the analysis of the information collected in order to provide the representative data for the activity of the sub-set of units connected to the communications network.

16. Procedure for measuring and analysing the activity on at least one communications network, according to any one of the preceding claims, characterised by the fact that the information collected by the server taken from the terminals will include, apart from the information describing each packet sent or received by the terminal, with the procedure including a later stage for segmenting the data, by comparison with each piece of information received by the server with a database containing a table for assigning the data.

17. Procedure for measuring and analysing the activity on at least one communications network, according to any one of the preceding claims, characterised by the fact that it includes an additional stage consisting of setting up a specific database for the client user of the procedure, containing at least all the data collected for the latter, with the client user having at his/her disposal the computerised means for consulting this specific database.

18. Procedure for measuring and analysing the activity on at least one communications network, according to at least one of the preceding claims, characterised by the fact that at least one target sampling application appears amongst the means for displaying on the said terminal whose contents depends on the said information relating to the data exchanged on the network.

19. Procedure for measuring and analysing the activity on at least one communications network, according to claim 18, characterised by the fact that an historical file for the responses provided for the said targeted samplings is created [and recorded] on the level of the said terminal.

20. Procedure for measuring and analysing the activity on at least one communications network, according to claim 18, characterised by the fact that an historical file for the responses provided for the said targeted samplings is created [and recorded] on the level of the server which sent the said application.

21. Procedure for measuring and analysing the activity on at least one communications network, according to any one of the preceding claims, characterised by the fact that it includes a stage for classifying the different types of activities on a communications network, a stage for specifying a restricted population of users forming a panel, with the said procedure including a subsequent stage for summarising the information analysed in order to provide some representative data on the activity of the sub-set of units connected to the communications network.

22. Procedure for measuring and analysing the activity on at least one communications network, according to any one of the preceding claims, characterised by the fact that the stage for the analysis of the information collected consists of processing at least part of the data, including the Internaut's identification code [Idᵢₙₜₑᵣₙₐᵤₜ]; the response to the request made [Id_{page}]; the date for the start of consulting the said response by the said Internaut [T_{pd}]; and the date of the end of the consultation of the result of the request from the said Internaut [T_{pf}], the identification code for the session [Idₛ], the start of the session [T_{S d}] corresponding to the start of a connection to the network by the said Internaut; the end of the said connection [Tₑₜ].

23. Procedure for measuring and analysing the activity on at least one communications network, according to claim 22, characterised by the fact that a Gross Day Point index (GDP) is determined based on the said information corresponding to the percentage of Internauts from the panel consulting a given page, multiplied by the number of days of connection per Internaut over a given period.

24. Procedure for measuring and analysing the activity on at least one communications network, according to claim 22, characterised by the fact that a Gross Session Point index (GssesP) is determined corresponding to the percentage of Internauts multiplied by the number of Web sessions per Internaut.

25. Procedure for measuring and analysing the activity on at least one communications network, according to claim 22, characterised by the fact that a GPP index is determined based on the said information, corresponding to the percentage of Internauts multiplied by the number of different WEB pages per Internaut.

26. Procedure for measuring and analysing the activity on at least one communications network, according to claim 22, characterised by the fact that a Gross Display Point (GdisP) index is determined based on the said information, corresponding to the percentage of Internauts multiplied by the number of pages, whether different or not, recorded per Internaut.

27. Procedure for measuring and analysing the activity on at least one communications network, according to claim 22, characterised by the fact that a GPP/GdisP Ratio index is determined based on the said information.

28. Procedure for measuring and analysing the activity on at least one communications network, according to claim 22, characterised by the fact that a Gross Duration Point (GdurP) index is determined based on the said information, corresponding to the percentage of Internauts multiplied by the duration in minutes of connection per Internaut.

29. Procedure for measuring and analysing the activity on at least one communications network, according to claim 22, characterised by the fact that a TARGET REACH index is determined based on the said information, corresponding to the number of Internauts from a given target, for a given domain, with respect to the number of individuals in the target.

30. Procedure for measuring and analysing the activity on at least one communications network, according to claim 22, characterised by the fact that a TARGET SHARE index is determined based on the said information, defined by the number of Internauts from the target who have visited a domain (site, sector, . . . ) with respect to the overall number of Internauts who have visited the domain (site, sector . . . ).

31. Procedure for measuring and analysing the activity on at least one communications network, according to claim 22, characterised by the fact that a TARGET DISPLAY SHARE index is determined based on the said information, defined by the number of pages hit by the target with respect to the number of pages hit for all the Internauts on the domain (site, sector . . . ).

32. Procedure for measuring and analysing the activity on at least one communications network, according to claim 22, characterised by the fact that a BANNER DISPLAY SHARE index is determined based on the said information, defined by the number of advertising banners seen by a target on a domain (site, sector . . . ) with respect to the number of advertising banners seen by the whole group of the Internauts on the domain (site, sector, . . . ).

33. Procedure for measuring and analysing the activity on at least one communications network, according to claim 22, characterised by the fact that a PAGES WITH BANNER DISPLAY SHARE index is determined based on the said information, defined by the number of pages with advertising seen by the target on the domain (site, sector . . . ) with respect to the number of pages with advertising seen by the whole group of Internauts on the domain (site, sector, . . . ).

34. Procedure for measuring and analysing the activity on at least one communications network, according to claim 22, characterised by the fact that a REACH AFFINITY index is determined based on the said information, defined by the proportion of visitors to the domain (site, sector . . . ) within the target group with respect to the proportion of the target group within the group of Internet users.

35. Procedure for measuring and analysing the activity on at least one communications network, according to claim 22, characterised by the fact that a DISPLAY AFFINITY index is determined based on the said information, defined by the number of pages seen by a target on a site, a domain or a service, with respect to the total number of pages seen on the site, the domain.

36. Procedure for measuring and analysing the activity on at least one communications network, according to claim 22, characterised by the fact that a BANNER AFFINITY index is determined based on the said information, defined by the percentage of advertising banners seen by a target on a site, a domain or a service, with respect to the total number of advertising banners seen on the site, the domain.

37. Procedure for measuring and analysing the activity on at least one communications network, according to claim 22, characterised by the fact that a PAGES WITH BANNER AFFINITY index is determined based on the said information, defined by the percentage of advertising banners seen by a target on a site, a domain or a service, with respect to the total number of advertising banners seen on the site, the domain or the service.

38. Procedure for measuring and analysing the activity on at least one communications network, according to any one of the preceding claims, characterised by the fact that it includes a subsequent stage for detecting advertising information through the analysis of the data collected by comparison with a reference, statistical compilation and behavioural database for the said information detected.

39. Equipment for the measurement of the activity, characterised by the fact that it includes a measurement server linked to the Internet network, with the said measurement server including a database in which the identification codes and the requests corresponding to the homepages requested by the users from the panel are recorded, and a calculator ensuring the detection and the processing of the requests generated by the users.
